(19) United States
(12) Patent Application Publication
(10) Pub. No.: US 2010/0089639 A1
(43) Pub. Date: Apr. 15, 2010

(54) SEAL-TIGHT GROMMET AND METHOD OF PRODUCING SAME

(75) Inventors: Patrick Bousquet, Merignac (FR); Xavier Manac'h, Bordeaux (FR); Philippe Descours, Cestas (FR)

Correspondence Address: DARBY & DARBY P.C., P.O. BOX 770, Church Street Station, New York, NY, 10008-0770, US

(73) Assignee: Thales, Neuilly Sur Seine (FR)

(21) Appl. No.: 12/467,710

(22) Filed: May 18, 2009

(30) Foreign Application Priority Data
May 16, 2008 (FR) 08 02666

(51) Int. Cl. H02G 3/18

(52) U.S. Cl. 174/652

(57) ABSTRACT

The invention relates to a sealing device for a chamber partition, the partition having an orifice enabling a strand of conductor wires to pass between the outside and the inside of the chamber. The device includes a plug through which passes the strand, and an apparatus to keep the plug pressed against the partition. The conductor wires can be kept away from one another inside the plug to ensure the seal-tightness of the plug itself. Advantageously, the plug is pressed into a void of a counter-form, the internal shape of the void substantially complementing an external shape of the plug. The form/counter-form assembly provides for a perfect seal-tightness.

### CROSS-REFERENCE TO RELATED APPLICATION

The present application claims the benefit of French Patent Application 0802666, filed May 16, 2008, which is hereby incorporated by reference in its entirety.

### BACKGROUND OF THE INVENTION

The present invention relates to a sealing device for a chamber partition, the partition comprising an orifice enabling a strand of conductor wires to pass between the outside and the inside of the chamber. Such a device is commonly called a grommet. The invention also relates to a sealing method for producing such a device.

Chambers are used in many scientific and industrial areas to make it possible to work in a contained atmosphere. This is notably the case for the electronics and microelectronics industry for which environment tests are performed on electronic or microelectronic devices in particular physico chemical conditions. In the event, these devices can be tested in conditions of temperature, of pressure and of medium that differ from those of the ambient environment. These conditions can notably correspond to corrosive atmospheres. The devices to be tested can also be subjected to radiations or vibrations. Generally, the chambers are used to isolate the devices to be tested from the outside environment. However, electronic or microelectronic devices, in order to be tested, generally have to be linked to a test bench. In most cases, this test bench is located outside the chamber for at least one of the following reasons: the test bench does not support the conditions inside the chamber; the results obtained by the test bench are influenced by the conditions inside the chamber; the test bench must be accessible to an operator. Consequently, the connection between the devices to be tested and the test bench must pass through the chamber while maintaining its seal-tightness.

According to a first solution, the cables linking the devices to be tested and the test bench pass through the chamber via an orifice provided in a partition of the chamber. A paste, for example a hardening paste, is applied around the cables in order to plug the orifice. This first solution presents several drawbacks, notably in terms of versatility and safety. A first drawback results from the fact that the paste is applied more or less irretrievably, rendering the fixing of the cables to the wall of the chamber virtually final. This virtually final fixing limits the use of the chamber to test benches and to electronic or microelectronic devices that are suited to the cables fixed to the chamber. A second drawback results from the fact that the seal-tightness between the inside and the outside of the chamber depends on the way in which the paste is applied, notably between the cables or, where appropriate, between the conductor wires that make up the cables. Consequently, the seal-tightness of the chamber is not guaranteed and risks posing problems for personnel in the vicinity of the chamber, notably when the chamber contains corrosive gases.

According to a second solution, the feed-through of the chamber is provided by an electrical connector passing through a wall of the chamber. A first cable links the devices to be tested to the electrical connector on the inside of the chamber and a second cable links the test bench to the electrical connector on the outside of the chamber. The seal-tightness is then provided at the level of the electrical connector. Although this solution presents advantages over the first solution, notably by simplifying the production of the seal-tightness of the orifice, it also presents drawbacks. A first drawback is the limitation of the possible connections between the devices to be tested and the test bench via the electrical connector. In particular, the number and type of conductor wires that can link the devices to be tested to the test bench depend directly on the characteristics of the connector. A second drawback is the degradation of the connection between the devices to be tested and the test bench, a degradation that is intrinsic to any insertion of electromechanical contacts. This drawback is all the more significant in the field of microwave signals.

### SUMMARY OF THE INVENTION

One aim of the invention is notably to overcome all or some of the abovementioned drawbacks by proposing a chamber partition pass-through that is flexible, hermetic and electrically neutral. To this end, the subject of the invention is a sealing device for a chamber partition, the partition comprising an orifice enabling a strand of conductor wires to pass between the outside and the inside of the chamber. According to the invention, the device comprises:
a plug through which passes the strand, and
means for keeping the plug pressed against the partition.

Another subject of the invention is a method of sealing an orifice of a chamber partition, the orifice enabling a strand of conductor wires to pass between the inside and the outside of the chamber. According to the invention, the method comprises the following steps:
simultaneously:
   maintaining, over a section of the strand, a relative spacing between the conductor wires to be passed into the orifice,
   coating the conductor wires with an elastic material over the section, the coating forming a plug,
assembling the plug against the partition.

The invention notably has the advantage that it enables all types of conductor wires to pass between the outside and the inside of the chamber while simply and cost-effectively ensuring the seal-tightness of the chamber.

### BRIEF DESCRIPTION OF THE DRAWINGS

The invention will be better understood, and other advantages will become apparent on reading the detailed description of an embodiment that is given by way of example, the description being given in the light of the appended drawings which represent:

FIG. 1, a diagrammatic cross-sectional view of a first exemplary embodiment of a sealing device according to the invention;

FIGS. 2a and 2b, respectively, a top view and a cross-sectional view of a first exemplary embodiment of counter-form of the sealing device;

FIG. 3, a diagrammatic cross-sectional view of an exemplary plug of the sealing device;

FIGS. 4a and 4b, respectively, a bottom view and a cross-sectional view of a second exemplary embodiment of counter-form;

FIGS. 5a and 5b, respectively, a top view and a cross-sectional view of a second exemplary embodiment of a sealing device according to the invention.

### MORE DETAILED DESCRIPTION

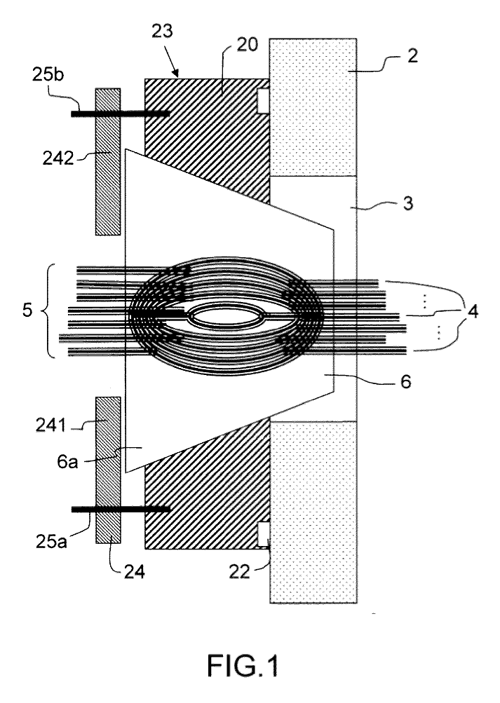

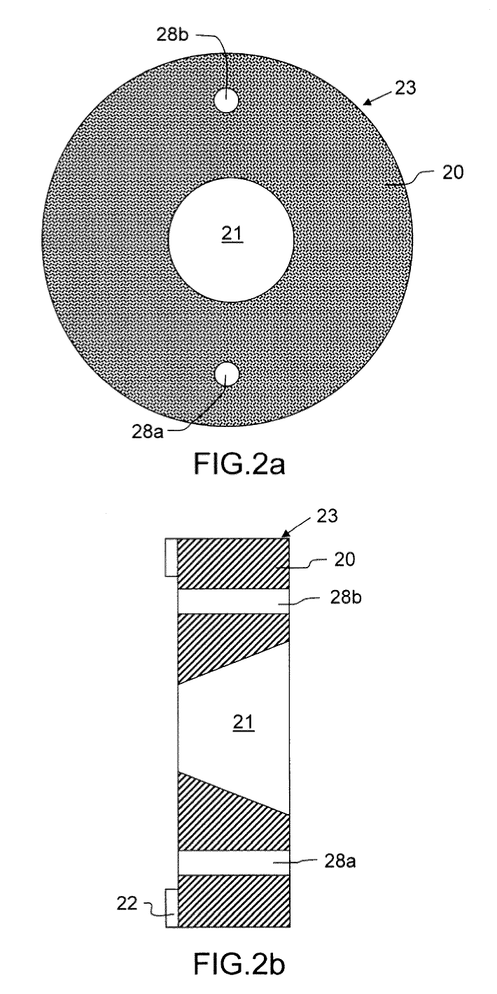

The general structure and the operating principle of the sealing device according to the invention can be described by first relying on FIGS. 1, 2a and 2b.

As FIG. 1 illustrates, the sealing device is designed to be mounted on a chamber partition 2, for example on the outside of the chamber. In this figure, only a part of the partition 2 of the chamber is represented. For the rest of the description, the term “chamber” should be understood to mean any enclosed space within which hardware tests can be performed. Advantageously, the chamber is seal-tight. However, the invention can be applied to any type of chamber, in the event, not seal-tight. The partition 2 comprises an orifice 3 enabling conductor wires 4 to pass between the outside and the inside of the chamber, or, more generally, between each side of the partition 2. The conductor wires 4 can be insulated from one another. The set of conductor wires 4 is called a strand 5. According to the invention, the sealing device comprises a plug 6 through which pass the conductor wires 4, and means for keeping the plug 6 pressed against the partition 2.

According to a first embodiment, not represented, the means for keeping the plug 6 pressed against the partition 2 comprise a rigid plate fixed to the partition 2, for example by means of fixing screws. In a first embodiment, the plug 6 comprises a shoulder bearing on the partition 2 around the orifice 3 and a projecting part on which bears the rigid plate. The seal-tightness of the chamber at the level of the orifice 3 is thus provided by the compression of the shoulder of the plug 6. In a second embodiment, the plug 6 comprises a part of tapered external form, a straight section of the truncated cone corresponding to the form (i.e., shape) of the orifice 3 of the partition 2, for example circular or rectangular, and a projecting part bearing on the rigid plate. In the two embodiments, the rigid plate can consist of two half-plates facing each side of the strand 5. This embodiment makes it possible to minimize the number of parts needed to produce the seal-tightness of the chamber at the level of the orifice 3.

According to a second embodiment, represented in FIGS. 1, 2a and 2b, the means for keeping the plug 6 pressed against the partition 2 comprise a counter-form 20, for example circular, and means for keeping the plug 6 pressed against the counter-form 20. The counter-form 20 can include a void 21, the form (i.e., shape) of which complements an external form of the plug 6. The counter-form 20 bears on the partition 2 via a seal 22 surrounding the orifice 3 of the partition 2, and the plug 6 is pressed into the void 21 of the counter-form 20. The counter-form 20 can comprise a rigid polyamide. It can be fixed to the partition 2 by screws passing into through-holes 28a and 28b in the counter-form 20. A perimeter 23 of the counter-form 20 is determined in order to enable the counter-form 20 to completely cover the orifice 3. This second embodiment, compared to the first; makes it possible to dissociate the form and the dimensions of the plug 6 from those of the orifice 3.

In one embodiment, the plug 6 has a tapered external form. This embodiment presents the advantage of enhancing the seal-tightness of the plug 6 itself when it comprises an elastomer. In practice, the form/counter-form combination, in the event, plug 6 and counter form 20, makes it possible to compress the form. Consequently, the material surrounding the conductor wires 4 is clamped around them, enhancing the seal-tightness along the conductor wires 4. In particular, a straight section of the tapered form of the plug 6 can form a circle. In other wards, the tapered form of the plug 6 can correspond to a truncated cone of revolution. This embodiment presents the advantage of the symmetry of revolution of the plug 6.

In one embodiment, the plug 6 and the void 21 are dimensioned so that the plug 6 comprises a projecting part 6a with respect to the counter-form 20. Because of this, the means for keeping the plug 6 pressed into the void 21 of the counter-form 20 can comprise a rigid plate 24 fixed to the counter-form 20, the rigid plate 24 compressing the projecting part 6a. The rigid plate 24 can notably comprise two half-plates 241 and 242, for example in half-moon form (i.e., a substantially semi-circular ring shape), each half-plate 241, 242 being fixed face to face on each side of the conductor wires 4. The use of half-plates 241 and 242 makes it possible to easily pass the conductor wires 4 in the middle of the rigid plate 24. The rigid plate 24 can be fixed by any removable fixing means such as screws 25a and 25b.

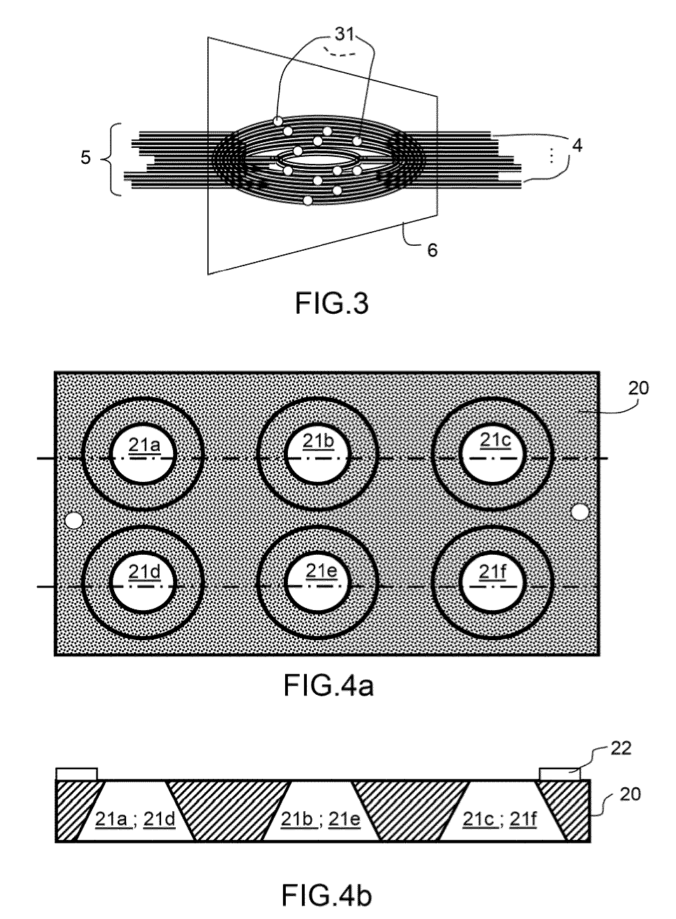

FIG. 3 uses a cross-sectional view to schematically illustrate an exemplary embodiment of a plug 6.

According to a particular embodiment, the plug 6 comprises an elastomer, for example silicone-based. This embodiment makes it possible to provide the seal-tightness either between the void 21 and the plug 6 or directly between the orifice 3 and the plug 6.

According to a particular embodiment, the plug 6 is produced by moulding. More specifically, the conductor wires 4 pass inside a mould, the internal form of which corresponds to that of the plug 6, and the material comprising the plug 6, for example an elastomer, is injected into the mould.

According to a particular embodiment, the sealing device comprises means for keeping the conductor wires 4 away from one another inside the plug 6. These means comprise, for example, means for giving an ovoid form to the strand 5 inside the plug 6. The term “ovoid” should be understood here in its general sense. In particular, the ovoid form covers both a spherical form and a form generally resembling an egg. As a general rule, it is assumed that the strand 5 has an ovoid form given that the latter can be obtained by bringing two ends of a section of the strand 5 together. In one embodiment, the means for keeping the conductor wires 4 away from one another comprise beads 31 situated inside the plug 6. The beads 31 can be threaded around each conductor wire 4, or around a majority of conductor wires 4. This embodiment is particularly advantageous when the conductor wires 4 do not have connectors at least one of their ends at the time of moulding of the plug 6, the beads 31 being able to be threaded easily around the connector wires. In the particular case, not represented, when all the beads 31 are arranged substantially in one and the same plane, the strand 5 takes an ovoid form. The beads 31 can be made of metallic material, for example of steel. In any case, in the case where the plug 6 is produced by moulding, the material comprising the beads 31 must be chosen so that the temperature of its melting point is greater than that of the melting point of the material comprising the plug 6.

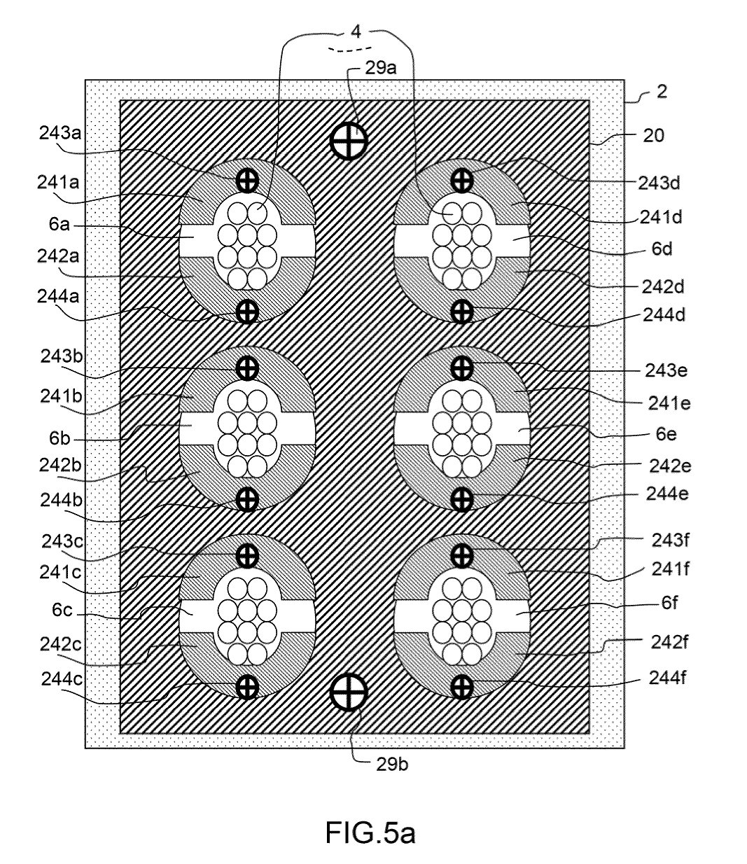

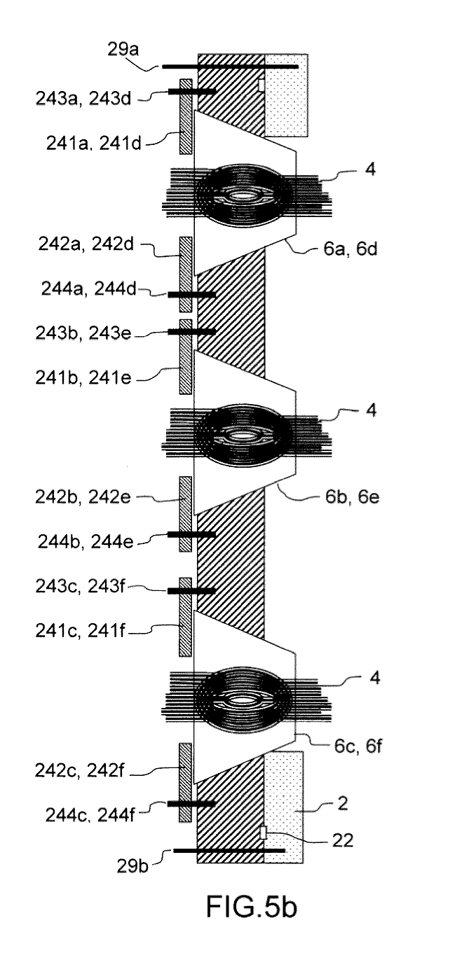

FIGS. 4a, 4b, 5a and 5b illustrate a variant of the sealing device according to the invention and show some of its advantages. According to this variant, the sealing device comprises several assemblies each comprising a plug 6 and a void 21, the conductor wires 4 passing through at least one of the plugs 6.

FIG. 4a represents, in bottom view, one embodiment of a counter-form 20. The same counter-form 20 is represented by cross-sectional view in FIG. 4b according to one of the axis lines of FIG. 4a showing the cross-section planes. In these figures, the counter-form 20 is of rectangular form. Moreover, it comprises six voids 21a, 21b, 21c, 21d, 21e and 21f, each void being able to receive a plug 6. These figures illustrate the possibility, according to the invention, of dissociating the form and the dimensions of the plug or plugs 6 from those of the orifice 3.

FIGS. 5a and 5b represent, respectively in top view and cross-section view, a sealing device comprising the counter-form 20 represented in FIGS. 4a and 4b. The counter-form 20 bears on the partition 2 via a seal 22 surrounding the orifice 3. A plug 6a-6f is arranged in each void 21a-21f and kept pressed by plates 241a-241f and 242a-242f in half-moon form fixed to the counter-form 20 by screws 243a-243f and 244a-244f. The counter-form 20 is itself fixed to the partition 2, for example by screws 29a and 29b. These figures illustrate the possibility, according to the invention, of passing conductor wires 4 of different types and sizes into different plugs 6a-6f. Furthermore, the conductor wires 4 do not necessarily pass through all the plugs 6a-6f. Thus, it is possible to easily adapt the conductor wires 4 linking a first device, such as a device to be tested, situated on one side of the partition 2, to a second device, such as a test bench, situated on the other side of the partition 2.

Another subject of the invention is a method of sealing an orifice 3 of a chamber partition 2 making it possible to obtain a sealing device as described hereinabove. According to the invention, the method comprises a first step of maintaining, over a section, a relative spacing between the conductor wires 4 to be passed into the orifice 3, a second step of coating the conductor wires 4 with an elastic material over the section to form a plug 6, and a third step of assembling the plug 6 against the partition 2. The first and second steps are performed simultaneously so that the conductor wires 4 are away from one another inside the plug 6.

According to a particular embodiment, the plug 6 has a tapered external form and the assembly of the plug 6 against the partition 2 comprises a step of assembly of a counter-form 20 on the partition 2, the counter-form 20 bearing on the partition 2 via a seal 22 surrounding the orifice 3, and a step of assembly of the plug 6 in a void 21 of the counter-form 20. The counter-form 20 can be produced according to one of the embodiments described hereinabove. In particular, the form of the void 21 of the counter-form 20 can complement the tapered form of the plug 6.

According to a first embodiment, the relative spacing between the conductor wires 4 is maintained by beads 31 threaded around each conductor wire 4.

According to a second embodiment, the relative spacing between the conductor wires 4 is obtained by a first step of clamping the conductor wires 4 at each end of the section where a plug 6 is to be formed and a second step of bringing the ends together to obtain an ovoid form of the strand 5.

According to a particular embodiment, the coating of the conductor wires 4 comprises a step of passing the conductor wires 4 through a mould, the internal form of which corresponds to that of the plug 6 and a step of injection of the elastic material into the mould.

1. A sealing device for a chamber partition, the chamber partition comprising an orifice enabling one or more strands of conductor wires to pass into a chamber, said device comprising:
a plug through which passes the one or more strands; and
an apparatus configured to press the plug against the chamber partition.

2. The sealing device according to claim 1, further comprising an apparatus configured to keep the one or more strands of conductor wires away from one another inside the plug.

3. The sealing device according to claim 2, wherein the apparatus configured to keep the one or more strands of conductor wires away from one another comprises an apparatus configured to shape the one or more strands into an ovoid shape inside the plug.

4. The sealing device according to claim 2, wherein the apparatus configured to keep the one or more strands of conductor wires away from one another comprises one or more beads threaded around each conductor wire.

5. The sealing device according to claim 1, wherein the apparatus configured to press the plug against the chamber partition comprises:
a counter-form having a void with an inner surface that substantially conforms to an external shape of the plug, the counter-form bearing on the chamber partition via a seal surrounding the orifice, and
an apparatus configured to press the plug into the void of the counter-form.

6. The sealing device according to claim 5, wherein the plug has a tapered external shape.

7. The sealing device according to claim 5, wherein the apparatus configured to press the plug into the void of the counter-form comprise a rigid plate fixed to the counter-form and bearing on a projecting part of the plug.

8. The sealing device according to claim 7, wherein the rigid plate comprises two rigid half-plates in the shape of a substantially semi-circular ring.

9. The sealing device according to claim 5 and comprising several assemblies each assembly comprising a plug and a void, the one or more strands of conductor wires passing through at least one of the plugs.

10. The sealing device according to claim 5, wherein the counter-form comprises a rigid polyamide.

11. The sealing device according to claim 1, wherein the plug comprises an elastomer.

12. The sealing device according to claim 11, wherein the elastomer of the plug is silicone-based.

13. A method of sealing an orifice of a chamber partition, the orifice enabling one or more strands of conductor wires to pass into a chamber, the method comprising the following steps:
maintaining, over a section of the one or more strands, a predetermined relative spacing between at least a portion of the conductor wires that pass into the orifice;
coating the one or more strands of conductor wires with an elastic material over the section, to form a plug; and
assembling the plug against the chamber partition.

14. The method according to claim 13, wherein the plug has a tapered external shape, and the step of assembling the plug against the chamber partition comprises the steps of:
assembling a counter-form on the chamber partition having a void with an inner surface that substantially conforms to the tapered shape of the plug, and the counter-form bearing on the chamber partition via a seal surrounding the orifice; and
assembling the plug into the void of the counter-form.

15. The method according to claim 13, wherein the relative spacing between each of the conductor wires is maintained by one or more beads threaded around each conductor wire.

16. The method according to claim 13, wherein the step of maintaining, over a section of the one or more strands, a predetermined relative spacing further comprises the steps of:
clamping the one or more strands of conductor wires at each end of the section; and
bringing the ends together to obtain an ovoid shape of the one or more strands.

17. The method according to claim 13, wherein the step of coating the one or more strands of conductor wires comprises the steps of:
passing the one or more strands of conductor wires through a mould having an internal shape that substantially conforms to an external shape of the plug; and
injecting the elastic material into the mould.
